(19) United States
(12) Patent Application Publication
(10) Pub. No.: US 2009/0109053 A1
(43) Pub. Date: Apr. 30, 2009

(54) REMOTE CONTROL DEVICE AND INFORMATION MANAGEMENT SERVER, METHOD, AND PROGRAM THEREFOR

(75) Inventor: Hidekazu Itoh, Saitama-shi (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/255,664

(22) Filed: Oct. 21, 2008

(30) Foreign Application Priority Data
Oct. 24, 2007 (JP) 2007-276824

(51) Int. Cl. G08C 19/00

(52) U.S. Cl. 340/825.69

(57) ABSTRACT

A remote control device information management server, an information management method, an information management program, and a remote control device that improve user convenience by executing a process with another remote control device. An audio-visual device includes a main body and a remote control device for controlling the main body. For example, a television includes a main body provided with an information server incorporating a control unit and a memory. The control unit of the information server receives processing request data from the television remote control device to issue an alarm from another remote control device and record data for having the other remote control device issue an alarm. The control unit further receives a processing data request from the other remote control device at a predetermined time and transmits processing instruction data, which includes data accordingly recorded to a memory, to the other remote control device.

### BACKGROUND OF THE INVENTION

The present invention relates to an information management server that manages information for a remote control device that remotely controls a control subject device such as an audio-visual device, an information management method for a remote control device, an information management program for a remote control device, and a remote control device.

An audio-visual (AV) device, such as a television or a video recorder, is often provided with a remote control device that remotely controls the AV device. Normally, a remote control device can remotely control only one device. Thus, the number of remote control devices increases as the number of remotely controllable devices, or control subject devices, increases.

Accordingly, Japanese Laid-Open Patent Publication No. 2002-218564 (FIGS. 1 and 2) describes an example of a technique that controls various devices with a single remote control device, or multi-remote control device. This technique uses a receiver, which receives information from an external information source, to perform remote controlling based on the information. The information received from the external information source is written and stored to memory. In accordance with an input operation performed by a user who is using the multi-remote control device, the information stored in the memory is transmitted from a transmitter to perform a remote control operation. Thus, a plurality of remotely controlled subject devices can be remotely controlled with a single remote control device.

When using a plurality of remote control devices to remotely control the associated devices, if a remote control device becomes lost, the associated device cannot be operated. In such a case, it is desirable that such a device be controllable by another remote control device. Further, if the battery level of a remote control device becomes low, it would be convenient if the battery level of other remote control devices can be checked so that the drained batteries of each remote control can be exchanged at the same time. Additionally, it would be convenient if the same device could be remotely controlled by another remote control device until the batteries have been exchanged.

In this way, convenience would be improved if a user could remotely control a device with a remote control device that is not associated with that device. However, with the multi-remote control device described in the above publication, various devices cannot be remotely controlled by other remote control devices.

### SUMMARY OF THE INVENTION

The present invention provides an information management server that manages information for a remote control device, an information management method for a remote control device, an information management program for a remote control device, and a remote control device that executes processes with other remote control devices to improve user convenience.

A first aspect of the present invention is an information management server for a remote control device. The information management server includes a memory and a control unit. The memory includes a data region which records data associated with a device identifier identifying a remote control device that remotely controls a control subject device. The control unit writes data to and reads data from the memory. The control unit includes a recording means for receiving from a first remote control device processing request data, which includes a subject device identifier identifying another second remote control device that is to perform a process and a message specifying the process, and recording the message to the memory in association with the subject device identifier. A data read means specifies a device identifier for the second remote control device when detecting an access by the second remote control device and uses the device identifier as the subject device identifier to obtain the associated message recorded in the memory. A transmission control means transmits processing instruction data including the obtained message to the remote control device identified by the subject device identifier.

A second aspect of the present invention is a method for managing information of a remote control device with a memory including a data region, which records data associated with a device identifier identifying a remote control device that remotely controls a control subject device, and a control unit, which writes data to and reads data from the memory. The method causes the control unit to perform a recording step of receiving from a first remote control device processing request data, which includes a subject device identifier identifying another second remote control device that is to perform a process and a message specifying the process, and recording the message to the memory in association with the subject device identifier. The method also causes the control unit to perform a data read step of specifying a device identifier for the second remote control device when detecting an access by the second remote control device and using the device identifier as the subject device identifier to obtain the associated message recorded in the memory. Further, the method causes the control unit to perform a transmission control step of transmitting processing instruction data including the obtained message to the remote control device identified by the subject device identifier.

A third aspect of the present invention is a program for managing information of a remote control device with a memory including a data region, which records data associated with a device identifier identifying a remote control device that remotely controls a control subject device, and a control unit, which writes data to and reads data from the memory. The program causing the control unit to function as a recording means for receiving from a first remote control device processing request data, which includes a subject device identifier identifying another second remote control device that is to perform a process and a message specifying the process, and recording the message to the memory in association with the subject device identifier. The program also causes the control unit to function as a data read means for specifying a device identifier for the second remote control device when detecting an access by the second remote control device and using the device identifier as the subject device identifier to obtain the associated message recorded in the memory. Further, the program causes the control unit to function as a transmission control means for transmitting processing instruction data including the obtained message to the remote control device identified by the subject device identifier.

A fourth aspect of the present invention is a remote control device serving as a first remote control device recording control information for remotely controlling a control subject device. The remote control device includes an information management server, a control means, and an operation means. The information management server includes a memory which records data that is transmitted to a remote control device and associated with a device identifier identifying a remote control device that remotely controls a control subject device. The control means transmits and receives data. The operation means receives a user instruction. The control means includes an instruction acceptance means for obtaining via the operation means a subject device identifier identifying a second remote control device that is to perform remote controlling for the first remote control device as a substitute of the first remote control device and a message specifying a substitute instruction process. The control means further includes a control information transmission means for transmitting to the information management server processing request data including the subject device identifier and substitute instruction process obtained by the instruction acceptance means and the control information.

A fifth aspect of the present invention is a remote control device serving as a second remote control device recording control information for remotely controlling a control subject device. The remote control device includes an information management server and a control means. The information management server includes a memory which records data that is transmitted to a remote control device and associated with a device identifier identifying a remote control device that remotely controls a control subject device. The control means transmits and receives data. The control means includes a processing instruction obtaining means for obtaining from the information management server processing instruction data including a requester device identifier identifying a first remote control device that is to perform remote controlling for the second remote control device as a substitute of the second remote control device and a message of a substitute acceptance process for having the second remote control device execute a transmission process on control information to have the first remote control device function as the substitute. The control means further includes a control information transmission means for transmitting to the information management server response data including the requester device identifier and the control information in accordance with the message of the substitute acceptance process.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating a plurality of AV devices and remote control devices for controlling the AV devices;

FIG. 2 is a block diagram illustrating a control unit of a remote control device and the interior of an information server;

FIG. 3 is a flowchart illustrating an alarm issue process; and

FIG. 4 is a flowchart illustrating a remaining battery level transmission process.

### DETAILED DESCRIPTION OF THE PREFERRED EMBODIMENTS

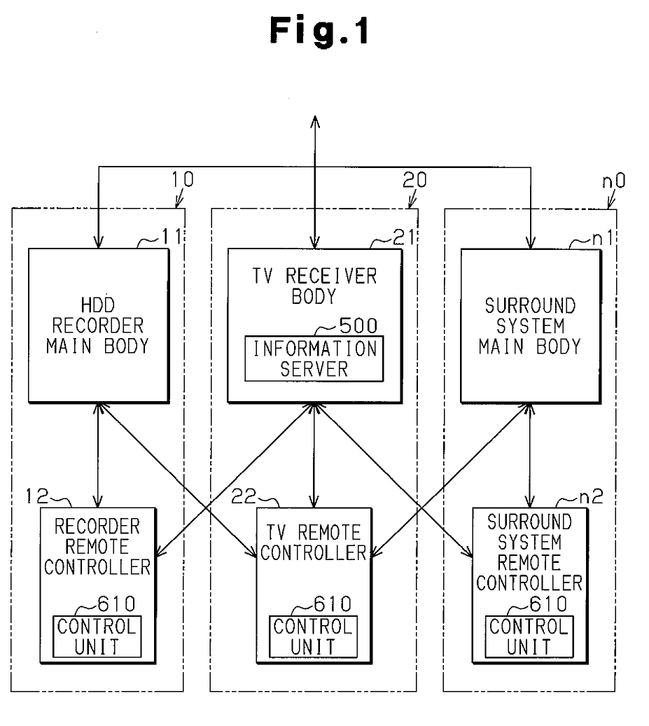

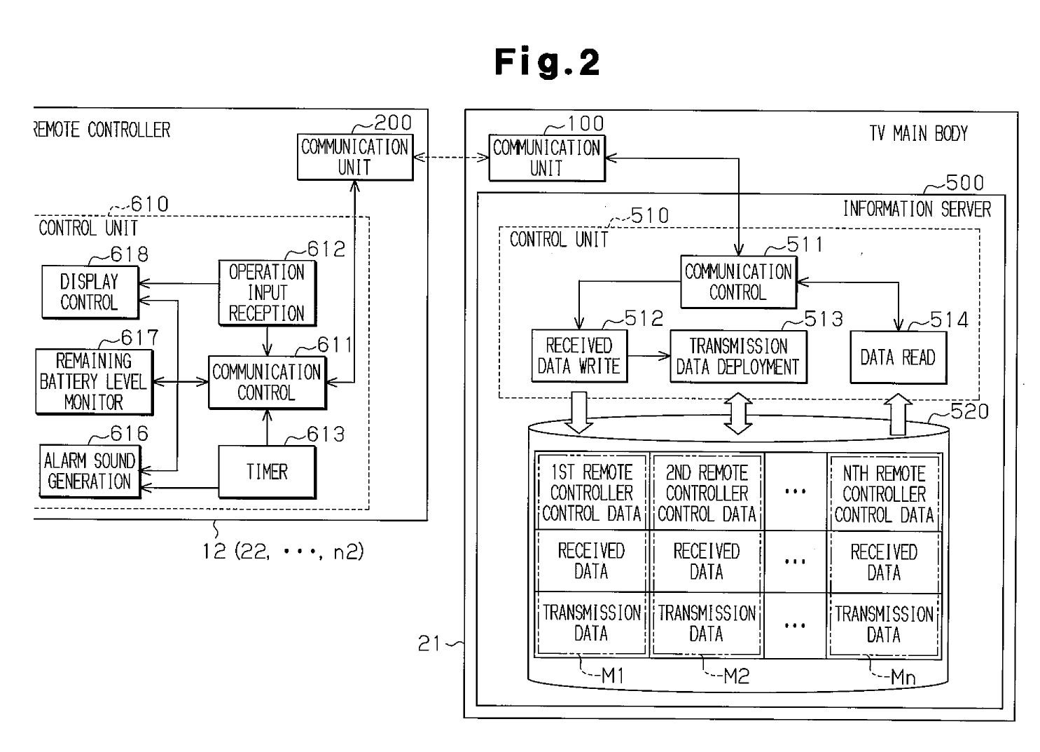

A preferred embodiment according to the present invention will now be discussed with reference to FIGS. 1 and 2. The preferred embodiment will be described as an information management server, an information management method, and information management program for a remote control device used to remotely control a plurality of AV devices in a house or building.

Referring to FIG. 1, a plurality of AV devices 10, 20, . . . , n0 are arranged in the house. In the preferred embodiment, the AV devices are an HDD recorder 10, a television 20, and a surround system n0, which are connected to one another through a network and connectable to the Internet via a computer terminal (not shown).

In the preferred embodiment, the AV devices 10, 20, . . . , n0 respectively include main bodies 11, 21, . . . , n1 and remote control devices 12, 22, . . . , n2. The main bodies 11, 21, . . . , n1 serve as control subject devices. The remote control devices 12, 22, . . . , n2 remotely control the associated main bodies 11, 21, . . . , n1. More specifically, the HDD recorder 10 includes an HDD recorder main body 11 and a recorder remote control device 12 for remotely operating the HDD recorder main body 11. The television 20 includes a television main body 21 and a television remote control device 22 for remotely operating the television main body 21. The surround system n0 includes a surround system main body n1 and a surround system remote control device n2 for remotely operating the surround system main body n1.

The main bodies 11, 21, . . . , n1 of the AV devices each include a communication unit 100 and a control unit, which are shown in FIG. 2, in addition to an operation unit. The operation unit includes various buttons, such as volume buttons and channel buttons. When a user selects one of these buttons, the operation unit provides a corresponding signal to the control unit. The communication unit 100 uses a wireless terminal identifier, which identifies the associated device to perform wireless communication and receive data from and send data to each of the remote control devices 12, 22, . . . , n2. The control unit executes a process that corresponds to an operation signal obtained from the operation unit or communication unit 100.

In the preferred embodiment, the television 20 includes an information server 500, which serves as an information management server for managing data related to remote controlling. The information server 500 is provided with data received by the communication unit of the television main body 21, as shown in FIG. 2.

The information server 500 includes a control unit 510 and a memory 520. The control unit includes a CPU, RAM, and ROM (not shown) and performs a process (including a recording step of received data writing and deployment, a data read step, and a transmission control step), which will be described later. By executing an information management program, the control unit 510 functions as a communication control means 511, which serves as a transmission control means, a received data write means 512, a transmission data deployment means 513, which serves as a deployment means, and a data read means 514. The received data write means 512 and the transmission data deployment means 513 function as a recording means.

The communication control means 511 exchanges data through wireless communication with the remote control devices 12, 22, . . . , n2 via the communication unit 100 of the television main body 21. The data transmitted from the remote control devices 12, 22, . . . , n2 includes recipient data for identifying the recipient remote control device to which data is transmitted, sender data for identifying the sender remote control device transmitting data, and content data of the transmitted data contents. Processing request data for requesting another remote control device to execute a process includes recipient data for identifying the remote control device that is to execute the process, sender data for identifying the sender remote control device issuing the request, and content data for showing a message (command) of the processing contents. Further, response data, which is generated when executing a process that was instructed by another remote control device, includes recipient data for identifying the recipient to which a response is to be sent, sender data for identifying the sender sending the response data, and content data of the response contents.

Further, when receiving a processing data request from any of the remote control devices 12, 22, . . . , n2, the communication control means 511 transmits processing instruction data, which includes data obtained by the data read means 514, to that remote control device. The processing instruction data includes a message for that remote control device.

The received data write means 512 writes the processing request data obtained by the communication control means 511, the response data, and the like to the memory 520.

The transmission data deployment means 513 executes a deployment process for recording data, which is recorded to a received data storage region of the memory 520, to a transmission data storages region for the recipient remote control device of the data.

The data read means 514 reads from the memory 520 the data that is recorded to the transmission data storage region corresponding to the remote control device specified by the data obtained by the communication control means 511.

The control unit 510 of the information server 500 further serves as a remote control device control data obtaining means, which obtains control data to function as the remote control device 12, . . . , n2 of another AV device 10, . . . , n0. More specifically, the remote control device control data obtaining means transmits specification information for specifying the AV device that is subject to remote controlling and obtains control data of the remote control device that remotely controls this AV device.

The memory 520 includes data regions that record data for the remote control devices 12, 22, . . . , n2 of the AV devices 10, 20, . . . , n0.

In the preferred embodiment, data regions M1, M2, . . . , Mn are provided in correspondence with the remote control devices. Each of the data regions M1, M2, . . . , Mn used respectively for the remote control devices further includes a control data storage region, a received data storage region, and a transmission data storage region.

The control data storage region records control data of each of the control subject devices stored in each of the remote control devices so that the television remote control device 22, which remotely controls the television main body 21 and includes the information server 500, can carry out the functions of the remote control devices 12, . . . , n2 for the other control subject devices. The control data is recorded in association with a wireless identifier for identifying each remote control device.

The received data storage regions record data received from the corresponding remote control device.

The transmission data storage regions record data received from the corresponding remote control device.

The remote control devices 12, 22, . . . , n2 each include an operation unit serving as an operation means, a communication unit 200, a sound generation unit, a display unit, and a control unit 610 serving as a control means. The operation unit includes various buttons, such as volume buttons and channel buttons. When a user selects one of these buttons, the operation unit provides a corresponding signal to the control unit 610. The communication unit 200 uses a wireless terminal identifier, which identifies the associated device to perform wireless communication and receive data from and send data to the associated AV device main body 11, 21, . . . , n2. The sound generation unit generates a buzzer sound based on an instruction from the control unit 610. The display unit is, for example, a display, and shows the obtained data based on an instruction from the control unit 610.

The control unit 610 includes a CPU, a RAM, a ROM, and a memory, which temporary stores data (none shown). Further, the control unit 610 includes a communication control means 611, an operation input reception means 612, a timer 613, an alarm sound generation means 616, a remaining battery level monitor means 617, and a display control means 618.

The communication control means 611 performs wireless communication to receive data from and send data to the information server 500 via the communication unit 200 of the remote control device 12, 22, . . . , n2.

When one of the buttons in the operation unit is selected, the operation input reception means 612 accepts the process corresponding to the selected button.

The timer 613 monitors time. Based on the time monitored by the timer 613, the control unit 610 transmits a processing data request to the information server 500 whenever a predetermined time (e.g., one hour) elapses.

In accordance with the processing instruction data, the alarm sound generation means 616 controls a process for outputting an alarm sound with the sound generation unit at a predetermined time.

In accordance with the processing instruction data, the remaining battery level monitor means 617 detects the remaining battery level of the remote control device 12, 22, . . . , n2 associated with the control unit 610 and provides the communication control means 611 with the detection.

The display control means 618 records the obtained processing instruction data. Then, based on a display instruction signal obtained from the operation input reception means 612, the display control means 618 shows a message on the display unit.

The processing management of the remote control devices 12, 22, . . . , n2 in the system described above will now be described. In one case described below, based on an instruction from a remote control device that has accepted an instruction from a user, another remote control device executes processing and completes a series of processes. In another case described below, a remote control device that has accepted an instruction from a user completes a series of processes by executing processing that is in accordance with response data from another remote control device. For the former case, an example in which the remote control device that has accepted a processing instruction to issue an alarm will be described. For the latter case, an example in which the remaining battery level is transmitted to each remote control device will be described.

### [Alarm Issue Process]

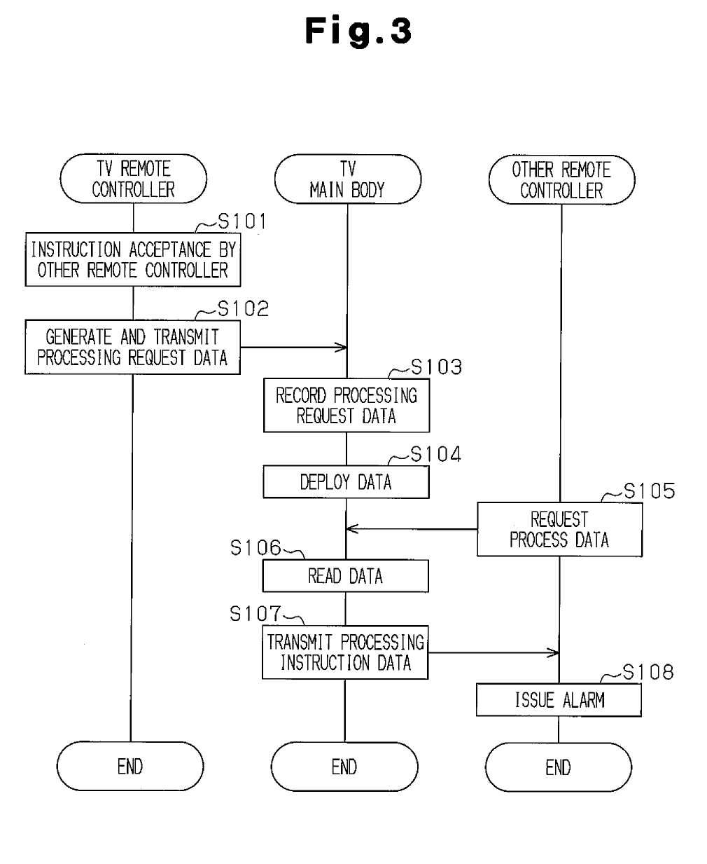

An alarm issue process will first be described with reference to FIG. 3. For example, if the recorder remote control device 12 becomes lost, the alarm issue process is performed to find the recorder remote control device 12. In this case, execution of the alarm issue processing is instructed by the television remote control device 22 (first remote control device) of the television main body 21 that includes the information server 500.

The user operates the buttons of the television remote control device 22 to instruct the recorder remote control device 12 of the HDD recorder 10 to execute the alarm issue process. As a result, the television remote control device 22 executes an instruction acceptance process for the other remote control devices 12, . . . , n2 (step S101). More specifically, the user uses the buttons of the television remote control device 22 to issue an alarm issue processing instruction and an instruction for locating the remote control device that is subject to the processing (i.e., the television remote control device 12). Further, the user sets a processing time at which the alarm is output. In this case, the user sets a time subsequent to a predetermined period (i.e., the time interval in which the remote control device subject to the alarm issue process). Then, the operation input reception means 612 in the control unit 610 of the television remote control device 22 provides the communication control means 611 with a command specifying the alarm issue process (alarm issue command), remote control device identification data specifying the remote control device subject to processing, and processing time data.

Next, the television remote control device 22 generates processing request data, which is sent to the information server 500 (step S102). More specifically, the communication control means 611 of the television remote control device 22 generates the processing request data based on the obtained alarm issue command, the remote control device identification data, and the processing time data. Then, the communication control means 611 sends the processing request data to the information server 500. The processing request data includes remote control device identification (subject device identifier) data serving as recipient data specifying the recorder remote control device that is subject to processing, remote control device identification data serving as sender data specifying the television remote control device 22, and the alarm issue command and processing time data serving as a message.

The control unit 510 of the information server 500 executes an instruction acceptance process. More specifically, the processing request data received by the communication unit 100 of the television main body 21 is provided to the communication control means 511 of the control unit 510. The communication control means 511 then provides the received data write means with the recipient data, sender data, and message that are included in the obtained processing request data.

Subsequently, the control unit 510 executes a recording process on the processing request data (step S103). More specifically, the received data write means 512 of the control unit 510 records the processing request data to the memory 520 in the received data storage region for the remote control device specified by the sender data included in the processing request data and records the processing request data. In the preferred embodiment, the control unit 510 records the received processing request data to the received data storage region for the television remote control device 22 as specified by the remote control device identification data, serving as the sender data, of the television remote control device 22.

Afterwards, the control unit 510 executes a data deployment process (step S104). More specifically, the transmission data deployment means 513 of the control unit 510 obtains the recipient data included in the processing request data recorded to the received data storage region and records the message to the transmission data storage region for the remote control device specified by the remote control device identification data in the recipient data. In this case, the recipient is the recorder remote control device 12. Thus, the message is recorded to the transmission data storage region for the recorder remote control device 12. After recording the message to the transmission data storage region, the transmission data deployment means 513 deletes the processing request data recorded to the received data storage region.

At the predetermined time, the remote control devices 12, 22, . . . , n2 each issue a processing data request (step S105). More specifically, in each remote control device, the communication control means 611 is activated when a predetermined period elapses based on the time of the timer 613 and sends a processing data request to the information server 500. The processing data request includes a request remote control device identifier for identifying the remote control device 12, 22, . . . , n2 sending the processing data request.

The control unit 510 of the information server 500 receives the processing data request from the remote control devices 12, 22, . . . , n2. More specifically, the communication control means 511 in the control unit 510 of the information server 500 is provided with the processing data request. The communication control means 511 then provides the data read means 514 with the request remote control device identifier included in the processing data request.

Next, the control unit 510 executes a data read process (step S106). More specifically, the data read means 514 of the control unit 510 reads a message recorded to the transmission data storage region for the remote control device specified by the provided request remote control device identifier. When a message is not recorded to the transmission data storage region, the communication control means 511 generates a transmission of data indicating that there is no processing instruction data.

Here, a message is recorded in the transmission data storage region. Thus, the data read means 514 reads the message. In this case, the message including the alarm issue command and the processing time data for the recorder remote control device 12 is retrieved. The data read means 514 provides the communication control means 511 with the read message together with the request remote control device identifier.

Then, the control unit 510 executes a transmission process for the processing instruction data (step S107). More specifically, the communication control means 511 of the control unit 510 generates processing instruction data with the message obtained through the data read means 514. The processing instruction data includes a message, which includes the alarm issue command and the processing time data. The communication control means 511 transmits the generated processing instruction data to the recorder remote control device 12 that is specified by the request remote control device identifier.

The control unit 610 of the recorder remote control device 12 receives the processing instruction data from the information server 500. More specifically, the communication control means 611 of the control unit 610 obtains the message received via the communication unit 200 of the recorder remote control device 12 and records the message to a memory in the control unit 610. Here, the communication control means 611 receives the alarm issue command as the message and thus executes the alarm issue process with the alarm sound generation means 616. In this case, the message includes the processing time data. Thus, the alarm sound generation means 616 of the control unit 610 compares the processing time with the time of the timer 613 and controls the sound generation unit to issue an alarm when the time of the timer 613 indicates the processing time (step S108). As a result, the recorder remote control device 12 issues a buzzer sound at the time specified by the user. This allows the user to find the recorder remote control device.

### [Remaining Battery Level Transmission Process]

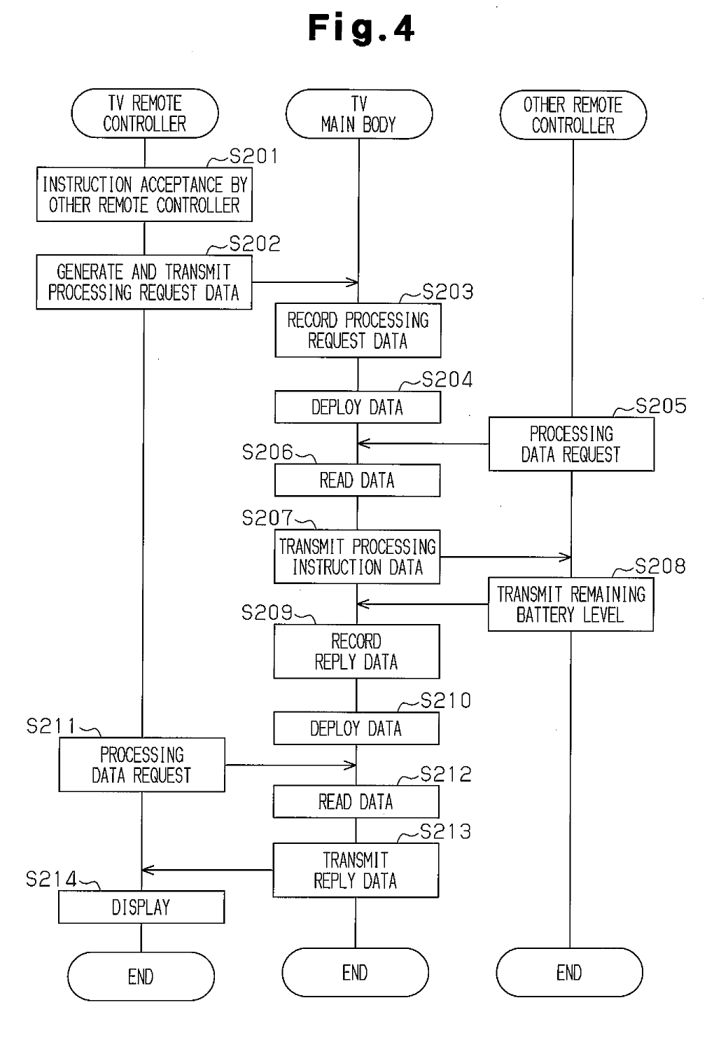

A process for generating a transmission of the remaining battery level from each of the remote control devices 12, 22, . . . , n2 will now be discussed with reference to FIG. 4. For example, when the battery level of one remote control device becomes low, the remaining battery level transmission process is executed so that the remaining battery level of the other remote control devices can be checked. This allows the user to exchange all of the batteries that are low on power at the same time. In this example, it is assumed that when the battery level is low in the television remote control device 22 (first remote control device) of the television main body 21, which includes the information server 500, the remaining battery levels of the other remote control devices (second remote control device) are checked.

The user operates buttons on the television remote control device 22 to select a process for generating a transmission of the remaining battery level from the remote control devices 12, . . . , n2. More specifically, the user uses the buttons on the television remote control device 22 to issue an instruction for checking the remaining battery level. As a result, the television remote control device 22 executes an instruction acceptance process on the other remote control devices 12, . . . , n2 (step S201). More specifically, the control unit 610 of the television remote control device 22 obtains instruction data (remaining battery level transmission command) for checking the remaining battery level from the operation input reception means 612. The operation input reception means 612 obtains subject identification data specifying the processing subject as every one of the remote control devices together with the remaining battery level transmission command. Then, the operation input reception means 612 provides the communication control means 611 with the subject identification data and the remaining battery level transmission command.

Next, the television remote control device 22 generates processing request data and transmits the processing request data to the information server (step S202). The communication control means 611 generates processing request data based on the obtained remaining battery level transmission command and the subject identification data. Then, the communication control means 611 transmits the processing request data to the information server 500 via the communication unit 200 of the television remote control device 22. The processing request data includes the subject identification data specifying the processing subject as every one of the remote control devices, remote control device identification data serving as sender data and specifying the television remote control device 22, and a remaining battery level transmission command as a message.

The control unit 510 of the information server 500 that has received the processing request data executes an instruction acceptance process and, in the same manner as in step S103, executes a processing request data recording process (step S203). The sender data included in the processing request data is remote control device identification data of the television remote control device 22. Thus, the control unit 510 records the processing request data to the received data storage region corresponding to the television remote control device 22. Then, in the same manner as in step S104, the control unit executes a data deployment process (step S204). Here, the recipient is every one of the remote control devices. Thus, the message is recorded to the transmission data storage region for each remote control device in the memory 520. The message includes a remaining battery level transmission command and a remote control device identification data specifying the remote control device that becomes the recipient (response recipient) of the transmission process. The sender data (remote control device identification data specifying the television remote control device 22) included in the processing request data for the deployment process is used as data related to the response recipient.

Afterwards, in the same manner as in step S105, the remote control devices 12, . . . , n2 issue a processing data request at a predetermined time (step S205). As a result, the control unit 510 of the information server 500 receives the processing data request from each of the remote control devices 12, . . . , n2. Then, in the same manner as in steps S106 and S107, the control unit 510 executes a data read process and transmits processing instruction data (steps S206 and S207). The processing instruction data generated here includes as a message the remaining battery level command and the response recipient data.

The control unit 610 of each of the remote control devices 12, . . . , n2 receives the message from the information server 500. The communication control means 61 of the control unit 610 receives the remaining battery level transmission command and response recipient data as the message. Accordingly, the control unit 610 performs a remaining battery level transmission process (step S208). More specifically, the remaining battery level monitor means 617 of the control unit 610 obtains data related to the remaining battery level of the remote control device incorporating the control unit and provides the data to the communication control means.

The communication control means 611 generates response data and sends the response data to the information server 500. The communication control means 611 includes in the response data related to the remaining battery level provided from the remaining battery level monitor means 617, data related to the response recipient, and sender data for specifying the remote control device sending the data.

The control unit 510 of the information server 500 receives response data from each of the remote control devices 12, . . . , n2. More specifically, the response data is provided to the communication control means 511 in the control unit 510 of the information server via the communication unit 100 of the television main body 21. The communication control means 511 provides the received data write means 512 with the received response data.

Next, the control unit 510 executes a response data recording process (step S209). In the response data recording process, the control unit 510 performs processes in the same manner as in steps S103 and 203. More specifically, the control unit 510 records the response data received from the remote control devices 12, . . . , n2 to the received data storage region in correspondence with the remote control device identification data of the sender data included in the response data. In this case, when data already exists in the received data storage region, the control unit 510 adds and sequentially accumulates new data in the received data storage region without deleting the existing data.

Afterwards, in the same manner as in steps S104 and S204, the control unit 510 executes a data deployment process (step S210). The transmission data deployment means 513 of the control unit 510 records the response data to the transmission data storage region for the remote control device specified by the response recipient data (remote control device identification data identifying the television remote control device 22) included in the response data. The response data includes data related to the remaining battery level and the remote control device identification data identifying the remote control device that send the data related to the remaining battery level.

Subsequently, in the same manner as in steps S105 and S205, the television remote control device 22 issues a processing data request at a predetermined time (step S211). Thus, in the same manner as in steps S106 and S206, the control unit 510 of the information server 500 executes a data read process (step S212). The response data is read from the transmission data storage region of the television remote control device 22. Further, the communication control means 511 of the control unit 510 transmits the response data, which is obtained via the data read means 514, to the television remote control device 22 (step S213).

The control unit 610 of the television remote control device 22 receives the response data from the information server 500. More specifically, the communication control means 611 of the control unit 610 records the response data, which is received via the communication unit 200, to the memory of the control unit 610 that temporarily stores data. Then, when receiving an instruction for indicating the remaining battery level from the user, the display control means 618 of the control unit 610 shows the data related to the remaining battery level included in the recorded response data together with data identifying the corresponding remote control device on the display unit (step S214). In this case, the display control means 618 may immediately (automatically) show the data without any instructions. The user can check the remaining battery level of the other remote control devices by looking at the display. Accordingly, the user can exchange all the batteries that are low on power at the same time.

The preferred embodiment has the advantages described below.

In the preferred embodiment, the television remote control device 22 generates processing request data in accordance with a user instruction and transmits the data to the information server 500 (step S102). The control unit 510 of the information server 500 executes a recording process on the processing request data (step S103), executes a data deployment process (step S104), and records a message to a transmission data storage region for the remote control device specified by the remote control device identification data of the recipient data. Upon receipt of a processing data request from the remote control devices 12, 22, . . . , n2, the control unit 510 of the information server 500 executes a data read process (step S106) and executes a processing instruction data transmission process (step S107). Based on an alarm issue command included in the processing instruction data, the control unit 610 of the recorder remote control device 12 issues an alarm (step S108). In this manner, the television remote control device 22 can be used to issue an alarm from the recorder remote control device 12 of the HDD recorder 10. Thus, the recorder remote control device 12 can be easily found due to the alarm.

In the preferred embodiment, the memory 520 records data in a data region allocated for each remote control device. Further, the data regions M1, M2, . . . , Mn for the remote control devices each include a received data storage region, which is for recording the data received from the corresponding remote control device, and a transmission data storage region, which is for recording data transmitted to the corresponding remote control device. During a recording process of the processing request data (step S103), the control unit 510 of the information server 500 records processing request data to the received data storage region for the remote control device specified by the sender data included in the processing request data. Then, in a data deployment process (step S104), the control unit 510 records a message to the transmission data storage region for the remote control device specified by the recipient data. Thus, the recipient and sender can be associated with each other from the data storage region that records data.

In the preferred embodiment, the remote control devices 12, 22, . . . , n2 each issue a processing data request at a predetermined time (step S105). In this case, the message that is to be transmitted to the remote control device issuing the processing data request is read. Then, processing instruction data generated with this data is transmitted. Thus, even if the remote control devices 12, 22, . . . , n2 are not used over a long period, the processing instruction data can be transmitted to the remote control devices to execute a process. Further, the remote control devices 12, 22, . . . , n2 receive processing instruction data only when a processing data request is issued and normally are not in a standby state for receiving data. This reduces power consumption of the remote control devices 12, 22, . . . , n2.

In the preferred embodiment, when instructing the recorder remote control device 12 of the HDD recorder 10 to execute an alarm issue process, the control unit 610 of the television remote control device 22 obtains processing time data together with an alarm issue command. The control unit 510 of the information server 500 transmits to the recorder remote control device 12 processing request data, which includes the processing time data. Since the message includes the processing time data, the control unit 610 of the recorder remote control device 12 compares the processing time with the timer time. When the timer time becomes the same as the processing time, the control unit issues an alarm (step S108). Thus, the recorder remote control device 12 issues a buzzer sound at the time specified by the user.

In the preferred embodiment, the control unit 510 of the information server 500 receives processing request data including a remaining battery level transmission command as a message (step S204). When receiving a processing data request (step S205), the control unit 610 of each of the remote control devices 12, . . . , n2 receives processing instruction data, which includes a remaining battery level transmission command, as a message from the control unit 510 and performs a remaining battery level transmission process (step S208). Then, the control unit 510 of the information server 500 executes a response data recording process (step 209) and executes a data deployment process (step S210). Afterwards, based on the processing data request (step S211), the control unit 610 of the television remote control device 22 receives the response data from the control unit 510 and records the response data to the memory. Upon receipt of an instruction from the user (or as soon as the response data is recorded to the memory), the control unit 610 shows the data related to the remaining battery level included in the response data together with the corresponding remote control device on the display unit (step S214). By looking as the display, the remaining battery level of other remote control devices can be checked. Accordingly, the user can check the remaining battery level of the other remote control devices 12, . . . , n2 with the television remote control device 22.

It should be apparent to those skilled in the art that the present invention may be embodied in many other specific forms without departing from the spirit or scope of the invention. Particularly, it should be understood that the present invention may be embodied in the following forms.

In the preferred embodiment, the alarm issue process is described as an example in which a series of processes are completed when, based on an instruction from a remote control device that accepts a user instruction, another remote control device executes a process. However, processing in which a series of processes are completed when a remote control device that receives an instruction executes a process is not limited in such a manner. For example, a remote control device (main remote control device) may execute a process for having another remote control device (substitute remote control device) carry out its functions. More specifically, the memory in each remote control device stores control data for remotely controlling a control subject device with the remote control device. The buttons on the operation unit of each remote control device are used to set an instruction reception method for receiving an instruction for executing a substitute instruction process that carries out its functions with another remote control device. In this case, in the same manner as the alarm issue process of the preferred embodiment, a substitute instruction process is executed. Thus, the control unit 610 of the main remote control device functions as an instruction reception means for obtaining from the operation means a message specifying the substitute instruction process and the subject device identifier identifying the substitute remote control device that performs remote control operations in place of the main remote control device. Further, the control unit 610 functions as a control information transmission means for transmitting to the information management server processing request data including the subject device identifier obtained by the instruction reception means, the substitute instruction process, and control information. A case in which the television remote control device 22 (first remote control device) serves as the main remote control device and the recorder remote control device 12 (second remote control device) serves as the substitute remote control device that carries out the functions of the television remote control device 22 will now be described in detail with reference to FIG. 3.

When the buttons of the television remote control device 22 are used to instruct a substitute instruction process, the television remote control device 22 executes the instruction reception process (step S101). More specifically, when accepting an instruction for executing the substitute instruction process, the operation input reception means 612 obtains the control data recorded to the memory and provides the communication control means 611 with the control data, and instruction command specifying the substitute instruction process (substitute instruction process command), and remote control device identification data identifying the remote control device subject to processing. In the same manner as the alarm issue process, the time at which the recorder remote control device substitutes the functions of the television remote control device 22 may be set and provided to the communication control means 611.

The control unit 610 of the television remote control device 22 sends to the information server 500 a message including the substitute instruction process command and the control data (and the processing time data) and processing request data including remote control device identification data serving as the recipient data and remote control device identification data serving as the server data (S102). In the same manner as in the alarm issue process, the control unit 510 of the information server 500 records the processing request data (step S103) and executes a data deployment process (step S104). In step S103, the control unit 510 may record the control data to a received data storage region instead of a control data storage region. In such a case, the memory 520 does not need to have a control data storage region that is separate from the received data storage region. Further, the control data may be retrieved from the processing request data and be recorded to the control data storage region for the corresponding remote control device so that in the data deployment process of step S104, data specifying the control data storage region is recorded to the transmission data storage region. In this case, the control data obtained from the original remote control device may be stored in the control data storage region.

Afterwards, when the recorder remote control device 12 issues a processing data request (step S105), the control unit 510 of the information server 500 executes a data read process (step S106) and then executes a transmission process on processing instruction data (step S107). In step S106, if a message including a substitute instruction process command and data specifying a control data storage region is recorded to the transmission data storage region, the data read means 514 of the control unit 510 retrieves control data from the specified control data storage region and includes the control data in the message of the transmission instruction data. Then, the control unit 610 of the recorder remote control device 12 receives processing instruction data from the information server 500 and records the message of the processing instruction data to the memory. The recorder remote control device 12 may remotely control the television main body 21 with the control data included in the received message. In this case, when the message includes a processing time, in the same manner as the alarm issue process, the television main body 21 may become remotely controllable from that time. By executing the process in the manner described above, for example, when the remaining battery level of the main remote control device becomes low, another remote control device (substitute remote control device) can be used to remotely control an AV device. This improves convenience for the user.

When the control data retrieved from the main remote control device is stored in the control data storage region, if a second substitute instruction process command is transmitted, the transmission of the control data may be omitted. The control unit 610, which retrieves the substitute instruction process command, checks whether the corresponding control data is stored in the information server 500. More specifically, the control unit 610 transmits its remote control device identification data, and the control unit 510 of the information server 500 generates a transmission indicating whether or not control data is recorded to the control data storage region for the remote control device that corresponds to the remote control device identification region. When data is not recorded and stored, the control unit 610 transmits processing request data including control data. When data is recorded, the control unit 610 transmits processing request data that does not include control data. As a result, when the control data is large, the load when transmitting and receiving data is reduced.

In the preferred embodiment, the remaining battery level transmission process is described as an example in which a series of processes are completed when, based on an instruction from a remote control device that accepts a user instruction, the remote control device executes a process in correspondence with response data from another remote control device. However, processing in which a series of processes are completed when a remote control device that transmits an instruction receives data from another remote control device, which executes the instructed process, and executes a process is not limited in such a manner. For example, a substitute remote control device may execute a substitute acceptance process for carrying out the functions of another remote control device (main remote control device). More specifically, the memory in each remote control device stores control data for remotely controlling a control subject device with the remote control device. An instruction method that uses the buttons on the operation unit of each remote control device is determined to issue an instruction for carrying out the functions of another remote control device. In this case, in the same manner as the remaining battery level transmission process of the preferred embodiment, a substitute acceptance process is executed. Thus, the control unit 610 of the main remote control device functions as a process instruction obtaining means for obtaining from the information management server a message specifying the substitute acceptance process and a requester device identifier identifying the first remote control device that will serve as a substitute for performing remote control operations. Further, when the message included in the obtained processing instruction data is the substitute acceptance process, the control unit 610 functions as a control information transmission means for transmitting to the information management server response data including the requester device identifier and control information. A case in which the television remote control device 22 (first remote control device) serves as the substitute remote control device that carries out the functions of the recorder remote control device 12 (second remote control device), which serves as the main remote control device, will now be described in detail with reference to FIG. 4.

When the buttons of the television remote control device 22 are used to instruct a substitute acceptance process, the television remote control device 22 executes the instruction reception process (step S201). More specifically, when accepting an instruction for executing the substitute acceptance process, the operation input reception means 612 provides the communication control means 611 with an instruction command specifying the substitute acceptance process (substitute acceptance process command) and remote control device identification data identifying the remote control device subject to processing. The control unit 610 of the television remote control device 22 transmits to the information server 500 a message including an instruction command and processing request data, which includes remote control device identification data serving as recipient data and remote control device identification data serving as sender data (S202). In the same manner as the alarm issue process, the control unit 510 of the information server 500 records the processing request data (step S203) and executes a data deployment process (step S204).

Afterwards, when the recorder remote control device 12 issues a processing data request (step S205), the control unit 510 of the information server 500 executes a data read process and then executes a transmission process on response data (steps S206, S207). The generated response data includes a substitute acceptance process command, transmission remote control device identification data, and data related to the recipient. When receiving a message from the information server 500, the control unit 610 of the recorder remote control device 12 executes a process for issuing a substitute acceptance request. More specifically, the control unit 610 of the recorder remote control device 12 obtains control data from a memory. Then, the recorder remote control device 12 generates response data, which includes the control data, transmission remote control device identification data of the recorder remote control device 12, and data related to the response recipient of the television remote control device 22. The response data is transmitted to the information server (step S208). The control unit 510 of the information server 500 executes a process for recording the response data (step S209) and executes a data deployment process (step S210). In this case, in the same manner as the substitute instruction process described above, the control data may be included in the response data and stored in the received data storage region of the memory. Alternatively, the control data may be recorded separately from the response data in a control data storage region. Subsequently, when the television remote control device 22 issues a processing data request (step S211), the control unit 510 of the information server 500 executes a data read process (step S212). Then, the control unit 510 sends the response data obtained in the data read process to the television remote control device 22 (step S213).

When receiving response data from the information server 500, the control unit 610 of the television remote control device 22 records the response data in a memory of the control unit 610 that temporarily stores data. When the user issues an instruction for remotely operating the HDD recorder main body 11 with the operation input reception means, the control unit 610 uses control data that is in accordance with the instruction to remotely control the HDD recorder main body 11. Accordingly, for example, when a remote control device that performs a remote operation becomes lost, in lieu of this remote control device (main remote control device), another remote control device (substitute remote control device) can be used to remotely control an AV device. This improves convenience for the user.

Further, when the control data of the main remote control device is recorded to the control data storage region through the substitute acceptance process or the substitute instruction process, even if the main remote control device cannot receive data from or transmit data to the information server due to battery drainage or the like, a substitute remote control device can carry out the functions of the main remote control device. In this case, control data does not have to be obtained from the main remote control device. Thus, the processes of steps S205 to S211 in FIG. 4 can be omitted. Accordingly, the control data, which is obtained through the substitute acceptance process and the substitute instruction process, can be associated with the main remote control device that transmits the control data and stored in the memory 520. This further increases versatility.

In the preferred embodiment, the memory 520 of the information server 500 includes a received data storage region for each remote control device. Instead, the memory 520 may include a common received data storage region or a common transmission data storage region. In such a case, data is recorded in the transmission data storage region in association with the recipient remote control device.

In the preferred embodiment, the control unit 510 transmits processing instruction data in accordance with a processing data request issued by the remote control devices 12, 22, . . . , n2 at predetermined time intervals. However, the transmission timing of the processing instruction data is not limited in such a manner. For example, the processing instruction data may be transmitted when the control unit 610 accesses the control unit 510. More specifically, after data is recorded to the transmission data storage region, the process instruction data may be transmitted when accessed by the corresponding remote control devices 12, 22, . . . , n2.

In the preferred embodiment, the control unit 510 of the information server 500 obtains data related to the remaining battery level of the remote control devices 12, 22, . . . , n2 from the remaining battery level monitor means 617 of each control unit 610. Instead, if the remote control devices 12, 22, . . . , n2 are located within a certain distance from the information server 500, the control unit 510 may predict the remaining battery level of the remote control devices 12, 22, . . . , n2 from the attenuation of radio waves during communication with the control units 610 of the remote control devices 12, 22, . . . , n2. When obtaining data related to the remaining battery level of a subject remote control device, response data is generated and recorded. Further, the control unit 610 of the remote control device 12, 22, . . . , n2 may not be able to transmit data due to battery drainage. In such a case, when data related to the remaining battery level of a remote control device cannot be obtained after a fixed period elapses, the control unit 510 of the information server 500 may determine that battery drainage has occurred. More specifically, data related to the longest time period required to obtain data from the control unit 610 of each of the remote control devices 12, 22, . . . , n2 is recorded as the fixed period in the control unit 510. During the data deployment process (step S204) executed after the recording process performed on the processing request data (step S203), the processing request data recording to the received data storage region is not deleted even if a message is recorded to the transmission data storage region. When response data is not received from the control unit 610 of each of the remote control devices 12, 22, . . . , n2 before the fixed period elapses, the control unit 510 determines that battery drainage occurred in the remote control devices 12, 22, . . . , n2 from which the response data was not received. The control unit 510 specifies the identifier of the remote control device from which response data was not received. Further, based on the processing request data that has been recorded to the received data storage region and has not been deleted, the remote control device transmitting the processing request data is specified, and a message is recorded to the transmission data storage region for this remote control device. The message includes remote control device identification data identifying the remote control device that transmitted the data related to the remaining battery level, data indicating an incommunicable state (data related to a remaining battery level of zero or data indicating that communication is out of range), and a display control command for executing a process for showing such situations.

In the preferred embodiment, a processing time, which is the time at which processing is performed, is set in the alarm issue process and the substitute instruction process. However, the execution time of processing is not limited in such a manner and may be a processing period (the period from when an instruction is issued to when the process is executed) or a processing initiation time and processing termination time. When using the processing period, the time at which a processing instruction is received is obtained by the remote control device from the timer 613, the obtained time and the processing period are both set and included in a message as the processing time. As a result, after the time specified by a user elapses, specified processes can be performed by other remote control devices.

In the preferred embodiment, a buzzer sound is generated as the alarm. Instead, if the remote control device includes a display or illuminated buttons, an alarm may be issued by showing an alarm on a message or illuminating the buttons.

In the preferred embodiment, the control unit 510 of the information server 500 executes an alarm issue process or a remaining battery level transmission process on each of the remote control devices 12, 22, . . . , n2. However, the present invention is not limited in such a manner and any process may be executed by another remote control device.

In the preferred embodiment, processing instruction data is obtained from the information server 500 when the remote control devices 12, 22, . . . , n2 issue a processing data request (S105, S205, S211). However, the present invention is not limited in such a manner, and the processing instruction data may be obtained when the remote control devices 12, 22, . . . , n2 obtain the information server. In this case, after or in parallel with execution of the process for which the remote control devices 12, 22, . . . , n2 accesses the information server, a process corresponding to the process instruction data can be executed.

In the preferred embodiment, an operation unit including buttons is used as the operation means. However, the operation means operated by the user to issue an instruction does not have to be an operation unit including buttons. For example, when a remote control device incorporates a touch panel, the touch panel may be used as an operation means.

The present examples and embodiments are to be considered as illustrative and not restrictive, and the invention is not to be limited to the details given herein, but may be modified within the scope and equivalence of the appended claims.

1. An information management server for a remote control device, comprising:
a memory including a data region that records data associated with a device identifier identifying a remote control device that remotely controls a control subject device; and
a control unit coupled to the memory that writes data to and reads data from the memory, the control unit including:
a recording means for receiving from a first remote control device a processing request data, which includes a subject device identifier identifying a second remote control device that is to perform a process and a message specifying the process, and writing the message to the memory in association with the subject device identifier;
a data read means for specifying a device identifier for the second remote control device when detecting an access by the second remote control device and using the device identifier as the subject device identifier to obtain the associated message recorded in the memory; and
a transmission control means for transmitting processing instruction data including the obtained message to the remote control device identified by the subject device identifier.

2. The information management server of claim 1, wherein:
the memory includes a received data storage region and a transmission data storage region that are associated with a device identifier; and
the processing request data includes a requester device identifier identifying the first remote control device; and
the recording means includes:
a received data write means for recording the message, which is included in the processing request data, to the received data storage region associated with the device identifier of the requester device identifier included in the received processing request data; and
a deployment means for recording the message, which is included in the processing request data, to the transmission data storage region associated with the device identifier of the subject device identifier included in the processing request data.

3. The information management server of claim 1, wherein:
the processing request data includes a message for generating response data transmitted to the first remote control device with data recorded to the second remote control device or data related to a process executed by the second remote control device;
the recording means records the response data to the memory in association with the device identifier of the first remote control device which is the response recipient;
the data read means obtains the response data recorded in the memory in association with the device identifier of the first remote control device when detecting an access by the first remote control device; and
the transmission control means transmits the obtained response data to the first remote control device.

4. The information management server of claim 1, wherein:
the remote control device records control information for controlling a control subject device remotely controlled by the remote control device;
the recording means obtains control information included in the processing request data or the response data and records the control information to the memory; and
the transmission control means transmits processing instruction data, which includes the control information recorded to the memory, to the second remote control device or transmits response data, which includes the control information recorded to the memory, to the first remote control device.

5. The information management server of claim 1, wherein the message included in the processing request data includes data related to a processing execution time.

6. A method for managing information of a remote control device, the remote control device having a memory including a data region that stores data associated with a device identifier identifying a remote control device that remotely controls a control subject device, and a control unit, which writes data to and reads data from the memory, the method causing the control unit to perform:
a recording step of receiving from a first remote control device processing request data, which includes a subject device identifier identifying a second remote control device that is to perform a process and a message specifying the process, and writing the message to the memory in association with the subject device identifier;
a data read step of specifying a device identifier for the second remote control device when detecting an access by the second remote control device and using the device identifier as the subject device identifier to obtain the associated message recorded in the memory; and
a transmission control step of transmitting processing instruction data including the obtained message to the remote control device identified by the subject device identifier.

7. (canceled)

8. A remote control device serving as a first remote control device that records control information for remotely controlling a subject device, the remote control device comprising:
an information management server including a memory that records data that is transmitted to a remote control device and associated with a device identifier identifying a remote control device that remotely controls the subject device;
a control means for transmitting and receiving data; and
an operation means for receiving a user instruction;
wherein the control means includes:
an instruction acceptance means for obtaining via the operation means a subject device identifier identifying a second remote control device that is to perform remote controlling for the first remote control device as a substitute of the first remote control device and a message specifying a substitute instruction process; and
a control information transmission means for transmitting to the information management server processing request data including the subject device identifier and a substitute instruction process obtained by the instruction acceptance means and the control information.

9. (canceled)
